(19) United States
(12) Patent Application Publication
(10) Pub. No.: US 2013/0236877 A1
(43) Pub. Date: Sep. 12, 2013

(54) SYSTEMS AND METHODS FOR PROVIDING EDUCATIONAL PRODUCTS AND SERVICES VIA CLOUD MASSIVE ONLINE OPEN COURSE

(71) Applicants: Andrew H. B. Zhou, Tiburon, CA (US); Dylan T. X. Zhou, San Gabriel, CA (US); Tiger T. G. Zhou, Tiburon, CA (US)

(72) Inventors: Andrew H. B. Zhou, Tiburon, CA (US); Dylan T. X. Zhou, San Gabriel, CA (US); Tiger T. G. Zhou, Tiburon, CA (US)

(21) Appl. No.: 13/868,262

(22) Filed: Apr. 23, 2013

Related U.S. Application Data
(63) Continuation-in-part of application No. 13/287,279, filed on Nov. 2, 2011.

(51) Int. Cl. G09B 5/08

(52) U.S. Cl. CPC G09B 5/08
USPC 434/350

(57) ABSTRACT

Provided are methods and systems for delivering educational products and services via a cloud massive online open course. Users may access the cloud massive online open course at any point of time using a networked client device. Educational resources are stored on a remote server of a cloud provider and are delivered to users over a network using cloud computing services. Users are also provided with tools for interaction within a cloud education environment. Along the learning process users of the cloud massive online open course may communicate with each other within the cloud education environment and share educational content with each other. Users' learning activity may be graded through online assessment.

### RELATED APPLICATIONS

This application is a Continuation-In-Part of U.S. patent application Ser. No. 13/287,279, filed on Nov. 2, 2011, titled “METHODS AND SYSTEMS TO ADVERTISE AND SELL PRODUCTS OR SERVICES VIA CLOUD GAMING ENVIRONMENTS,” which is incorporated herein by reference in its entirety for all purposes.

### FIELD

This application relates generally to cloud learning and, more specifically, to systems and methods for providing educational products and services via cloud massive online open course.

### BACKGROUND

This invention relates to the field of educational systems in general and to educational systems and method for providing cloud-based massive open online courses and for remote delivery of educational material.

The current educational systems do not provide the opportunity for all students with diverse backgrounds, capabilities, accessibility needs, and geographic locations to get knowledge necessary for success in a desired profession and future life. Now in the age of digital media, the best content, and the best people to teach, co-learn, and share with are accessible on the network, making centralized models less efficient. In other words, the traditional model of a class room is outdated—it limits our access to other people, other content and other means of learning.

In this challenging environment, cloud-based computing has become an increasingly attractive option for delivering educational products and services to a diverse global audience from different cultural backgrounds all over the world.

Within a cloud-based education environment, learners and educators act as the users and producers of cloud-based learning services. They have complete control over the choice, use and sharing of the educational tools and content provided by these services. This approach allows learners to learn anywhere and at anytime. It also facilitates collaboration among learners and educators. Additionally, the openness, sharing, and reusability of educational tools and content within cloud environment are technically enabled and promoted.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are systems and methods for providing educational products and services via a cloud massive online open course.

In certain embodiments, the system may include a processing module configured to provide educational recourses to one or more users over a network. In certain embodiments, at least a portion of the educational recourses may be stored on a remote server of a cloud provider and may be provided to the one or more users in the form of cloud computing recourses. The processing module may be also configured to provide tools for interaction between the one or more users within a cloud educational environment. The processing module may be also configured to provide, to the one or more users, a feedback that includes assessment of the learning activity of the one or more users within the cloud education environment.

In certain embodiments, the system may further include an input module configured to receive a request from one or more users to access the cloud massive online open course. The input module may be also configured to receive data associated with learning activity of the one or more users within the cloud education environment.

In certain embodiments, the processor may be further configured to provide, to the one or more users, multimedia resources including: a text, an audio, a still image, an animation, a video, and one or more interactivity content forms.

In certain embodiments, the system further comprises a database configured to store data associated with the one or more users on the remote server of the cloud provider.

Provided also is a method for providing educational products and services via a cloud massive online open course. In certain embodiments, the method may comprise receiving a request from one or more users to access the cloud massive online open course and providing educational recourses to one or more users over a network. In some embodiments, at least a portion of the educational recourses may be stored on a remote server of a cloud provider and may be provided to the one or more users in the form of cloud computing services. The method may also comprise providing tools for interaction between the one or more users within a cloud educational environment. The method may further comprise receiving data associated with learning activity of the one or more users within the cloud education environment and based on the data, providing a feedback to the one or more users. The feedback may include assessment of the learning activity of the one or more users within the cloud education environment.

In certain embodiments, the cloud computing services may be provided and managed by the cloud provider.

In certain embodiments, the cloud computing services include: Infrastructure as a Service, Software as a Service, Platform as a Service, and Network as a Service.

In certain embodiments, users may access the cloud massive online open course using a networked client device. The networked client device may include a desktop computer, a laptop, a tablet device, a mobile phone, a wearable personal digital device, a television set, a gaming device, a broadcasting device, a thin client, and so forth.

In some embodiments, the method may further comprise storing data associated with the one or more users on the remote server of the cloud provider.

In some embodiments, the interaction between the users may be provided through a cloud massive online open course network and may include group collaboration among learners and educators, team discussion, peer-review, online assessment, examination, and sharing of the educational resources. The interaction may be provided through a network of the cloud massive online open course

In some embodiments, the cloud massive online open course may include a public cloud massive online open course, a community cloud massive online open course, a hybrid cloud massive online open course, and a private cloud massive online open course.

In some embodiments, the method may further comprise providing catalogues of the educational products or services allowing the users to obtain, configure, and deploy the educational recourses themselves. The catalogues of the educational products or services may include templates that contain predefined configurations and technical information used by the one or more users to build a cloud education infrastructure.

In some embodiments, the users may be charged a fee for entering the cloud educational environment and using the educational resources.

In some embodiments, the method may further comprise displaying advertisements within the cloud educational environment. The advertisements may be associated with the educational products or services provided by the cloud provider. Alternatively, the advertisements may be associated with products or services provided by a third party.

In some embodiments, the method may further comprise identifying an interaction level of the one or more users with the one or more third party advertisements. The method may further comprise determining a fee payable by the third party based on the interaction level of the one or more users with the one or more third party advertisements.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 illustrates an example environment for implementing various aspects of methods and systems for providing educational products and services via a cloud massive online open course, in accordance with certain example embodiments.

FIG. 2 is a block diagram showing various modules of the system for providing educational products and services via a cloud massive online open course, in accordance with certain embodiments.

FIG. 3 illustrates a detailed representation of cloud computing services provided within a cloud education environment, in accordance with certain example embodiments.

FIG. 4 illustrates types of cloud massive online open courses, in accordance with certain example embodiments.

FIG. 5 is a flow chart illustrating a method for providing educational products or services via a cloud massive online open course, in accordance with certain example embodiments.

### DETAILED DESCRIPTION

Systems and methods for providing educational products and services via a cloud massive online open course are described herein. The cloud massive online open course is an online course that may be free and open to everyone with essentially unlimited enrollment. The cloud massive online open course may be accessed over the web by thousands of learners and educators at a time.

The system for providing educational products and services via the cloud massive online open course may be configured to facilitate communication between users of the system, such as exchanging information, comments, or other feedback or input between users. Data communicated within a cloud education environment may be point-to-point encrypted to provide copyright protection of the data. The system may provide access to educational resources (product and services), which may be stored on a remote server of a cloud provider. The cloud provider may manage infrastructures and platforms with education applications. Users may be provided with education applications that may be hosted centrally on cloud platforms. The system may entrust various remote cloud education services with user data, software and computation. The educational resources may include research, curriculum design, content generation (such as textbooks), teaching, assessment, quizzes, exams, granting degrees, and so forth. The educational resources may be provided in the form of a dynamically displaying video clip or slide show. Free educational recourses may be provided to users over a network with embedded advertisements within a multimedia stream. The educational resources may be accessed by users at any time, for example, through the Internet via a browser on a networked client device. The instructional design of the cloud massive online open course may include a crowd-sourced interaction and feedback via a cloud massive online open course network, for example group collaboration, team discussion on forums, peer-review, and automated feedback through online assessments, quizzes, tests, and exams. The cloud massive online open course may provide re-configurable analytic statistics associated with learners feedbacks, learners questions, educators answers, peer discussions, grading, reviewing, and examinations. At the end of the course users may be provided with a transfer credit at a degree-granting university or a certificate of completion of the course.

In some example embodiments, data associated with the learning activity of one or more users may be automatically provided to an authorized institution, wherein the data is stored in a database and includes learning progress, interaction activity, and grading.

In some example embodiments, the cloud massive online open course may include the uploading tools enabling a user to upload to the cloud massive online open course data associated with a learning experience of the user, a problem solving solution, and an educational video clip, which, when authorized, become a part of the educational resources. The user may be provided with a compensation for uploading the data.

In some example embodiments, the cloud massive online open course may include tools for evaluating and providing statistics of the learning activity of one or more users. The statistics may include learning potential, user's strength/weakness in a subject, future professional suitability, target virtual exam score, and the like. The statistics of a personal learning activity of a user may be sold to the user.

In some example embodiments, the cloud massive online open course may include a cloud database for storing a created student record. The student record may include information associated with the learning activity of a student. The student record may be sold to an entity that is interested in evaluation of professional ability or education level of the student.

In some example embodiments, the cloud massive online open course may include educator interaction means to enable educators to update or edit at least a portion of education recourses.

In some example embodiments, the cloud massive online open course may include a cloud search engine configured to conduct a keyword search of information requested by users. The information requested by the users may include a text, an audio, a video, an image, data about instructors, and the like.

Users may learn based on on-demand self-services that allow users to obtain, configure, and deploy cloud educational resources and services themselves using cloud education catalogues, without requiring the assistance of IT professionals. Users may access the cloud massive online open course through any networked client device, such as a desktop computer, a laptop, a tablet device, a mobile phone, a wearable personal digital device, a television set, a gaming device, a broadcasting device, and a thin client. Thus, users who desire to learn an educational subject may control where, what, how, with whom they learn. Learning happens in a more informal setting. Students don't need a degree to follow the course, only the willingness to learn.

In some example embodiments, the cloud massive online open course may include an open free online course aiming at large-scale participants. The open free online course may include open educational resources including distance learning university courses.

In some example embodiments, the cloud massive online open course may include a specialized course, a job-oriented course, a course for passing a test, and the like. The cloud massive online open course may also include traditional courses studied in colleges and universities.

In some example embodiments, the cloud massive online open course may include a massive amount of content produced in a plurality of universities, which is aggregated as a news letter, a web page, a mobile application, and a piece of multimedia accessible by the one or more users.

In some example embodiments, the cloud massive online open course may include user interaction tools enabling the one or more users to form connections with each other through autonomous, open, diverse, and interactive discourse.

In some example embodiments, the cloud provider may organize users in a predetermined setting, time and place through a network using dedicated online tools. The cloud massive online open course may include tools for conducting examinations via a webcam.

In some example embodiments, the cloud provider may slit expenses associated with certification fees and tuition fees with one or more educational institutions that provide online education courses.

In some example embodiments, an open source code may be provided for the cloud massive online open course platform, including the open source code for at least learning management systems, course authoring tools, application programming interfaces for integrating third-party learning objects, and machine grading application programming interfaces.

Thus, with the cloud massive online open course students can learn beyond time zones and physical boundaries, and can be connected across disciplines and institutional walls. Students do not need a degree to follow the course, only willingness to learn, they can improve their lifelong learning skills by forcing themselves to think about their own learning and knowledge absorption. The cloud massive online open course may create a new type of future university without centralized campus but everywhere in the world.

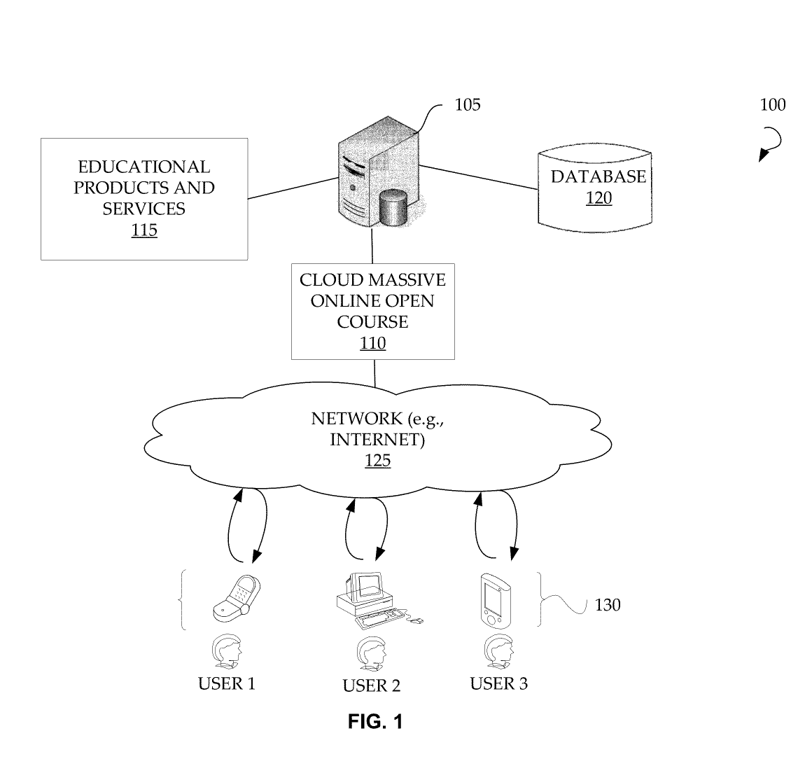

Referring now to drawings, FIG. 1 illustrates an example environment for implementing various aspects of methods and systems for providing educational products and services via a cloud massive online open course, in accordance with certain embodiments. As shown in FIG. 1, the environment 100 may include a remote cloud server 105 configured to host educational products and services 115 to be provided to users 130 via a cloud massive online open course 110 over a network 125 (typically the Internet). The network 125 may be also used for communication among various users 130 of the system.

The network 125 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 125 may include any suitable number and type of devices, e.g., routers and switches, for forwarding commands, content, and/or web object requests from each client to the online community application and responses back to the clients.

The methods described herein may also be practiced in a wide variety of network environments (represented by network 125) including, for example, TCP/IP-based networks, telecommunications networks, wireless networks, etc. In addition, the computer program instructions may be stored in any type of computer-readable media. The program may be executed according to a variety of computing models including a client/server model, a peer-to-peer model, on a stand-alone computing device, or according to a distributed computing model in which various functionalities described herein may be affected or employed at different locations.

In some example embodiments, at least a portion of educational products and services may be stored in a database 120 on a remote cloud server 105 of a cloud provider. The educational products and services 115 may be delivered to users 130 as cloud computing services via network 125. Users' data, software, and computation may be also stored on remote cloud server 105.

In some example embodiments, users may access education software and databases via a cloud massive online open course 110. The cloud massive online open course 110 may include tools for interaction between the one or more users within a cloud education environment via a cloud massive online open course network. The cloud massive online open course allows users to form connections through autonomous, diverse, open, and interactive discourse. Throughout the course of study users (learners) may interact with others, for example, experts, peer mentors and/or other learners by sharing educational materials, lectures, notes, discussing educational subjects, working in groups, etc. For example, a student during his study course may do homework, write assays, take tests, and provide all these materials to the system for assessment.

In some example embodiments, users 130 may access the cloud massive online open course using networked client devices, such as desktop computers, laptops, tablet devices, mobile phones, wearable personal digital devices, television sets, gaming devices, broadcasting devices, thin clients, and so forth.

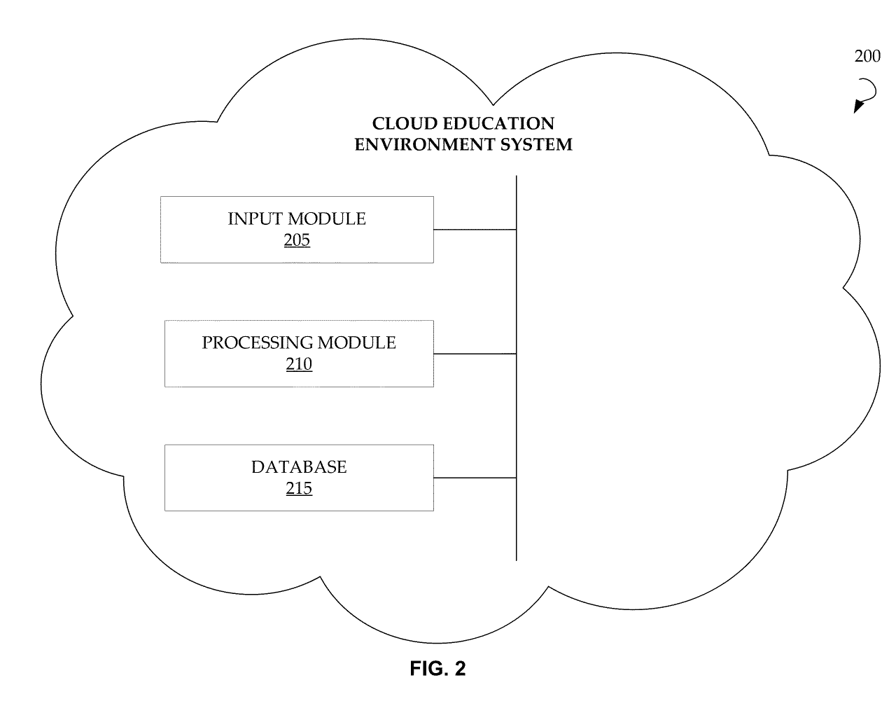

FIG. 2 is a block diagram showing various modules of the system for providing educational products or services via a cloud massive online open course, in accordance with certain embodiments.

The cloud education environment system 200 may be implemented, for example, on a remote cloud server (component 105 in FIG. 1) or some other forms of computer systems.

The cloud education environment system 200 may include an input module 205 for receiving a request from one or more users to provide educational resources. Input model may be further configured to receive data associated with learning activity of the one or more users within the cloud education environment.

The cloud education environment system 200 may include a processing module 210 for providing educational recourses to one or more users over a network. At least a portion of the educational recourses may be stored on a remote server of a cloud provider and may be provided to the one or more users in the form of cloud computing recourses. Processing module 210 may be also employed to provide tools for interaction between the one or more users within a cloud education environment.

Processing module 210 may be further configured to provide a feedback to the one or more users based on the data associated with the learning activity of the one or more users within the cloud education environment. The feedback may include assessment of the learning activity of the one or more users within the cloud education environment. The assessment may be automatically implemented by an assessment module incorporated in the system. Alternatively, other users of the system may act as experts or peer-viewers to check and assess the student's education activity. Based on the materials provided by the student and the assessment executed either automatically or by other users, the system may provide feedback to the student, which may include graded homework, test results, and the like. The cloud massive online open course may generate massive quantities of data about user behavior, which may be used to understand cognitive growth and how to improve learning process

In some example embodiments, processing module 210 may be further configured to display an advertisement in a cloud education environment. The advertisement may be associated with an educational product or service provided by a cloud provider or with a product or service provided by a third party. Processing module 210 may be also used for identifying an interaction level of one or more users with an advertisement while one or more users interact with the cloud education environment. The interaction level may be used for determining a fee payable by a third party based on the interaction level of the one or more users with the third party advertisement.

In some example embodiments, cloud gaming environment system 200 may include a database 215. Database 215 may be used to store a user's data, software, and computation.

In some example embodiments, database 215 may as well be used to store advertisement content to be displayed in the cloud education environment.

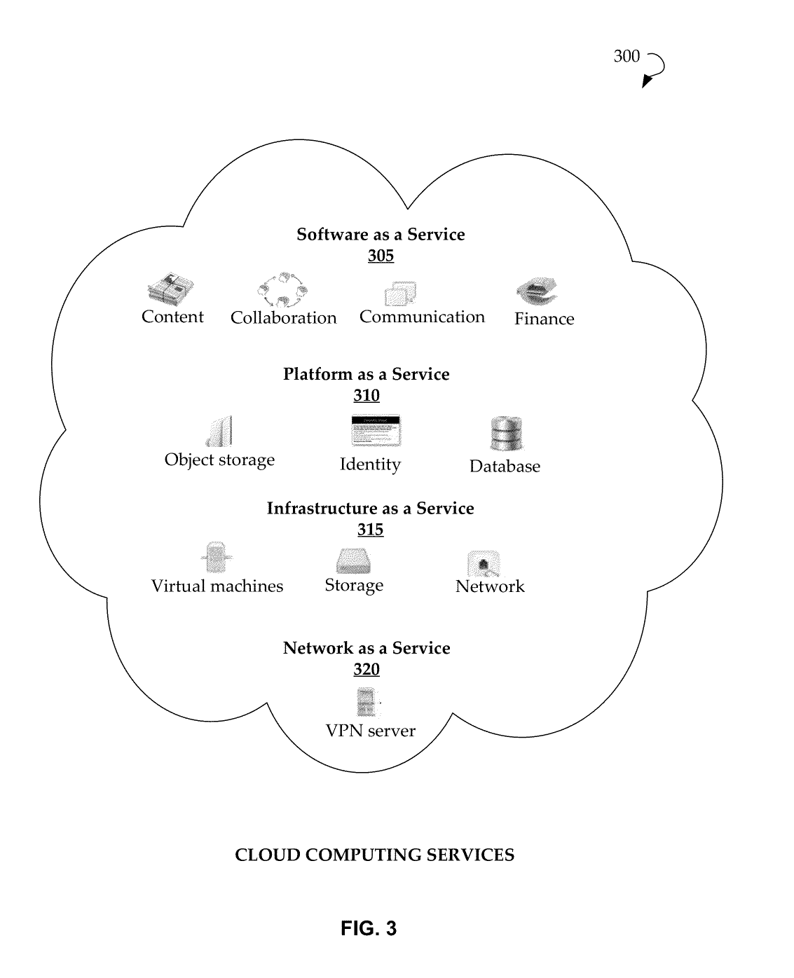

FIG. 3 illustrates a detailed representation of cloud computing services provided within a cloud education environment, in accordance to certain example embodiments. The cloud computing services include: Software as a Service 305, Platform as a Service 310, Infrastructure as a Service 315, and Network as a Service 320. The cloud computing services may be provided and managed by a cloud provider.

In some example embodiments, as part of Software as a Service 305, a cloud provider may install and operate education software in the cloud and cloud users may access the software from client devices. Cloud users do not manage the cloud infrastructure and platform where the educational application runs. This eliminates the need to install and run the educational application on the cloud user's own computers, which simplifies maintenance and support. Cloud-based education software may include desktop as a service, education process as a service, test environment as a service, communication as a service, etc.

In some example embodiments, Platform as a Service 310, a cloud provider may deliver a computing platform typically including operating system, programming language execution environment, database, and a web server. Users may develop and run their education software solutions on a cloud platform without the cost and complexity of buying and managing the underlying hardware and software layers. Users may create the education software using tools and/or libraries from a cloud provider. Users may also control software deployment and configuration settings. The cloud provider may provide networks, servers, storage, and other services. Platform as a Service 310 may also include facilities for application design, application development, testing and deployment as well as services such as team collaboration, web service integration and marshalling, database integration, security, scalability, storage, persistence, state management, application versioning, application instrumentation and developer community facilitation.

In some example embodiments, as part of Infrastructure as a Service 315, a cloud provider may offer computers—physical or (more often) virtual machines and the ability to scale educational services up and down according to users' varying requirements. Infrastructure as a Service 315 may offer additional resources such as images in a virtual-machine image-library, raw (block) and file-based storage, firewalls, load balancers, IP addresses, virtual local area networks (VLANs), and software bundles. The cloud provider may supply these resources on-demand from a large pool installed in data centers. For wide-area connectivity, users may use either the Internet or carrier clouds (dedicated virtual private networks). To deploy their applications, users may install operating-system images and their application software on the cloud education infrastructure. As a part of Infrastructure as a Service 315, users may patch and maintain the operating systems and the education software.

In some example embodiments, as part of Network as a Service 320, a cloud provider may provide to users network/transport connectivity services and/or inter-cloud network connectivity services. Network as a Service 320 may include server(s), network switch, router, workstations, USB, and printer connectivity all connected in the cloud. Cloud network may run totally isolated to any other network within private/public clouds. There is no need for private links, dedicated internet connections to connect to the network.

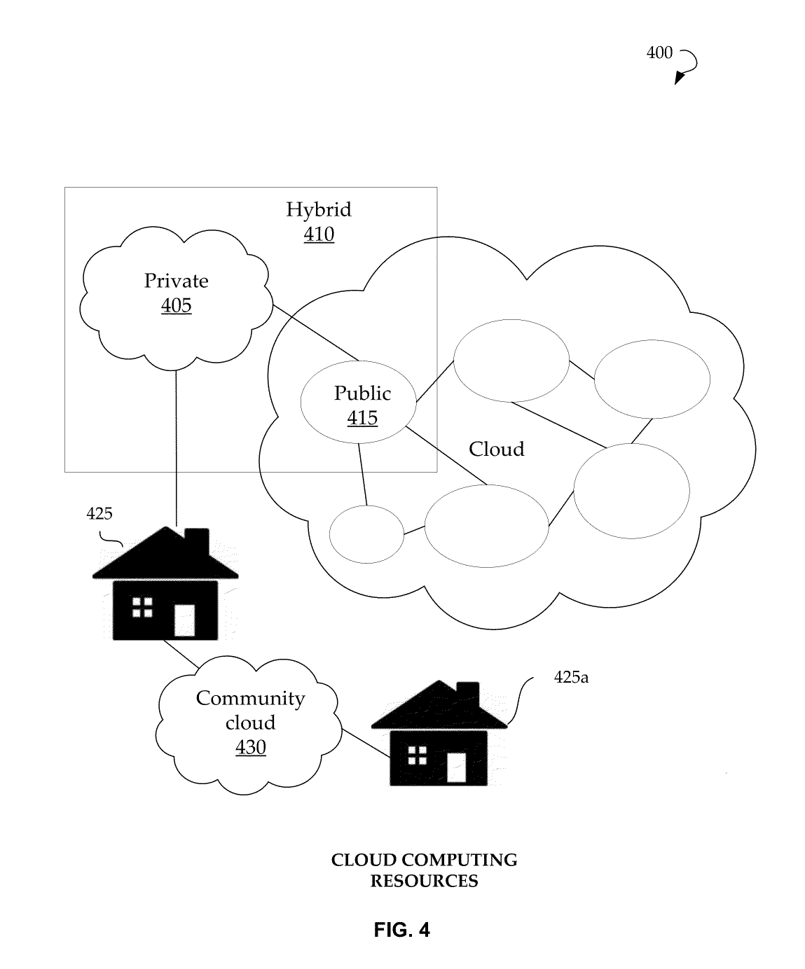

FIG. 4 illustrates types of cloud massive online open course, in accordance to certain example embodiments. The cloud massive online open course may include a private cloud massive online open course 405, a hybrid cloud massive online open course 410, a public cloud massive online open course 415, and a community cloud massive online open course 430.

The private cloud massive online open course 405 may be a private cloud course existing within a shared or public cloud (i.e. the Intercloud). The private cloud massive online open course 405 may be an on-demand configurable pool of shared education resources in a public cloud, isolated between the tenants of the public cloud. The isolation between tenants of a public cloud may be performed via access control mechanism.

The hybrid cloud massive online open course 410 may be a composition of two or more clouds (private, community or public) that remain unique entities but are bound together, offering the benefits of multiple deployment models. By utilizing the architecture of the hybrid cloud massive online open course 410, users may be able to obtain degrees of fault tolerance combined with locally immediate usability without dependency on internet connectivity. The architecture of hybrid cloud massive online open course 410 may include both on-premises resources and off-site (remote) server-based cloud infrastructure.

The public cloud massive online open course 415 may be available to the general public by a cloud provider. Education products and services may be free or offered on a pay-per-use model. Generally, public cloud provider may own and operate a cloud education infrastructure and offer access via Internet.

Community cloud massive online open course 430 may share cloud education infrastructure between several organizations 425, 425a from a specific community with common concerns (security, audit, commerce, etc.), whether managed internally or by a third-party and hosted internally or externally. The costs may be spread over fewer users than a public cloud (but more than a private cloud), so only some of the cost savings potential of cloud computing may be realized.

In some embodiments, the cloud massive online open course may include one or more catalogues of the educational products or services allowing the one or more users to obtain, configure, and deploy the educational recourses themselves. The catalogues may include a list of educational products and services grouped by categories and allow for searching (especially when hundreds or thousands of services are available). To make selection easier and to speed service deployment, educational product and service definitions may be standardized in the cloud catalogs. A user may select a desired educational product or service and see the description and details. The user may enter any pertinent information (contact information, service-specific questions) and submit the request for the educational products or services. The user may change the configuration of the technologies used to deliver the educational products or services based on cost, performance, and technology improvements.

In some embodiments, the catalogues of the educational products or services may include education pre-built templates that contain predefined configurations and technical information that may be used by users to build a cloud education infrastructure.

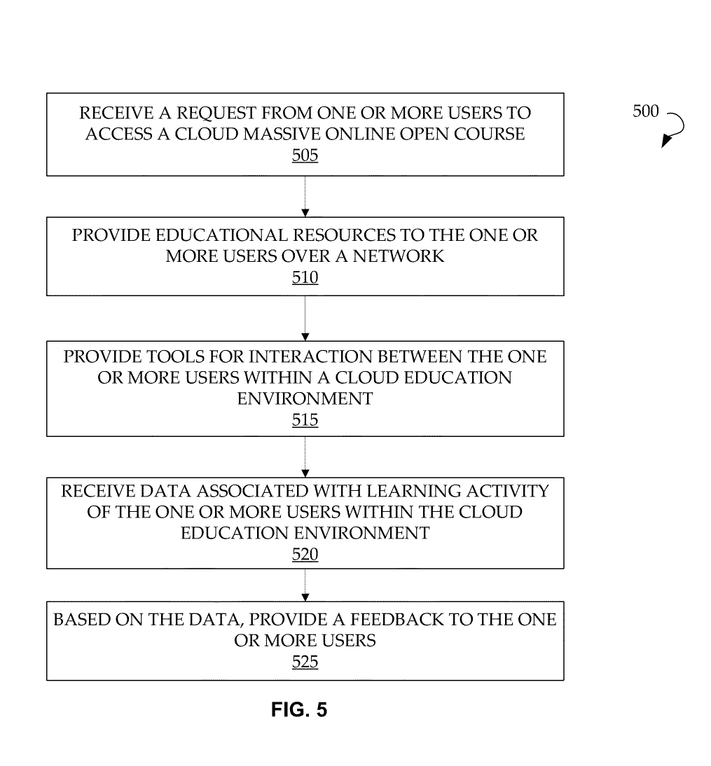

FIG. 5 is a flow chart illustrating a method for providing educational products or services via a cloud massive online open course, in accordance with certain embodiments. The method 500 may start with a cloud provider remote cloud server receiving a request from one or more users to access the cloud massive online open course at operation 505. Educational recourses may be provided to the one or more users over a network at operation 510. At least a portion of the educational recourses may be stored on the remote server of the cloud provider and may be provided to the one or more users in the form of cloud computing services. The cloud computing services may be provided and managed by the cloud provider. Thus, maintenance of the cloud computing applications is easier, because they do not need to be installed on each user's computer and may be accessed from different places.

At operation 515, the remote server may provide tools for interaction between the one or more users within a cloud educational environment. The interaction may be realized through a cloud massive online open course network. The interaction may include group collaboration among learners and educators, team discussion, peer-review, online assessment, examination, and sharing of the educational resources. The cloud massive online open course allows participants to form connections through autonomous, diverse, open, and interactive discourse.

At operation 520, the remote server may receive data associated with learning activity of the one or more users within the cloud education environment. The data may show the level of acquired knowledge of the provided educational resources. At operation 525, the remote server based on the data, may provide a feedback to the one or more users. The feedback may include assessment of the learning activity of the one or more users within the cloud education environment. The assessment of educational subject knowledge, technical skills, and/or professional skills of the one or more users may include interviews and/or gathering of feedback, for example, in oral and/or written form, from others who have interacted with a learner during the educational course, including but not limited to, experts, peer mentors, and/or other learners. For example, a learner may take a quiz at the end of his learning course and receive feedback from one or more experts and/or peer mentors and/or other learners concerning his acquired knowledge in a particular educational subject area.

Thus, various systems and methods for providing educational products or services via a cloud massive online open course have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A method for providing educational products and services via a cloud massive online open course, the method comprising:
receiving a request from one or more users to access the cloud massive online open course;
providing educational recourses to the one or more users over a network, wherein at least a portion of the educational recourses is stored on a remote server of a cloud provider and is provided to the one or more users in the form of cloud computing services;
providing tools for interaction between the one or more users within a cloud education environment;
receiving data associated with learning activity of the one or more users within the cloud education environment;
based on the data, providing a feedback to the one or more users, wherein the feedback includes assessment of the learning activity of the one or more users within the cloud education environment.

2. The method of claim 1, wherein the cloud computing services include: Infrastructure as a Service, Software as a Service, Platform as a Service, and Network as a Service.

3. The method of claim 1, further comprising entrusting a remote cloud education services with user data, software and computation.

4. The method of claim 1, wherein the cloud provider manages an infrastructure and a platform with education applications hosted centrally.

5. The method of claim 1, further comprising providing one or more education applications to the one or more users, wherein the one or more education applications are hosted centrally on a cloud platform.

6. The method of claim 1, wherein the cloud computing services are provided and managed by the cloud provider.

7. The method of claim 1, further comprising providing, to the one or more users, multimedia resources including: a text, an audio recording, a still image, an animation, a video recording, and one or more of interactivity content forms.

8. The method of claim 1, wherein the one or more users access the cloud massive online open course using a networked client device, wherein the networked client device includes: a desktop computer, a laptop, a tablet device, a mobile phone, a wearable personal digital device, a television set, a gaming device, a broadcasting device, and a thin client.

9. The method of claim 1, further comprising storing data associated with the one or more users on the remote server of the cloud provider.

10. The method of claim 1, wherein the interaction includes: group collaboration among learners and educators, team discussion, peer-review, online assessment, examination, and sharing of the educational resources.

11. The method of claim 1, further comprising providing re-configurable analytic statistics associated with learners feedbacks, learners questions, educators answers, peer discussions, grading, reviewing, and examinations.

12. The method of claim 1, wherein the educational resources are provided in the form of a dynamically displaying video clip or slide show.

13. The method of claim 1, further comprising providing educator interaction means to enable educators to update or edit at least a portion of education recourses.

14. The method of claim 1, further comprising providing a user with a transfer credit at a degree-granting university or a certificate of completion of a course.

15. The method of claim 1, further comprising automatically providing data associated with the learning activity of the one or more users to an authorized institution, wherein the data is stored in a database and includes learning progress, interaction activity, and grading.

16. The method of claim 1, further comprising providing uploading tools enabling a user to upload to the cloud massive online open course data associated with a learning experience of the user, a problem solving solution, and an educational video clip, which, when authorized, become a part of the educational resources.

17. The method of claim 16, further comprising providing compensation to the user for uploading the data.

18. The method of claim 1, further comprising evaluating and providing statistics of the learning activity of the one or more users, wherein the statistics includes learning potential, user's strength/weakness in a subject, future professional suitability, and target virtual exam score.

19. The method of claim 18, further comprising selling to a user the statistics of a personal learning activity of the user.

20. The method of claim 1, further comprising creating and storing a student record in a cloud database, wherein the student record includes information associated with the learning activity of a user.

21. The method of claim 20, further comprising selling the student record to an entity that is interested in evaluation of professional ability or education level of a student.

22. The method of claim 1, wherein the interaction is provided through a cloud massive online open course network.

23. The method of claim 1, wherein the cloud massive online open course includes: a public cloud massive online open course, a community cloud massive online open course, a hybrid cloud massive online open course, and a private cloud massive online open course.

24. The method of claim 1, further comprising providing one or more catalogues of the educational products or services allowing the one or more users to obtain, configure, and deploy the educational recourses themselves.

25. The method of claim 24, wherein the one or more catalogues include templates that contain predefined configurations and technical information used by the one or more users to build a cloud education infrastructure.

26. The method of claim 1, wherein the one or more users are charged a fee for entering the cloud education environment and using the educational resources.

27. The method of claim 1, wherein providing educational recourses to the one or more users over a network comprises providing free educational resources with embedded advertisement within a multimedia stream.

28. The method of claim 27, wherein the one or more advertisements are associated with the educational products or services provided by the cloud provider.

29. The method of claim 27, wherein the one or more advertisements are one or more third party advertisements associated with products or services provided by a third party.

30. The method of claim 29, further comprising identifying an interaction level of the one or more users with the one or more third party advertisements.

31. The method of claim 30, further comprising determining a fee payable by the third party based on the interaction level of the one or more users with the one or more third party advertisements.

32. The method of claim 1, further comprising point-to-point encryption of data communication within the cloud education environment.

33. A system for providing educational products and services via a cloud massive online open course, the system comprising:
a database;
a processing module configured to:
provide educational recourses to one or more users over a network, wherein at least a portion of the educational recourses is stored on a remote server of a cloud provider and is provided to the one or more users in the form of cloud computing recourses;
provide tools for interaction between the one or more users within a cloud education environment;
an input module configured to:
receive a request from one or more users to access the cloud massive online open course;
receive data associated with learning activity of the one or more users within the cloud education environment;
wherein the processing module is further configured to:
provide, based on the data, a feedback to the one or more users, wherein the feedback includes assessment of the learning activity of the one or more users within the cloud education environment.

34. The system of claim 33, wherein the cloud computing services include: Infrastructure as a Service, Software as a Service, Platform as a Service, and Network as a Service.

35. The system of claim 33, wherein the cloud computing services are provided and managed by the cloud provider.

36. The system of claim 33, wherein the processor is further configured to provide, to the one or more users, multimedia resources including: a text, an audio, a still image, an animation, a video, and one or more interactivity content forms.

37. The system of claim 33, wherein the one or more users access the cloud massive online open course using a networked client device, wherein the networked client device includes: a desktop computer, a laptop, a tablet device, a mobile phone, a wearable personal digital device, a television set, a gaming device, a broadcasting device, and a thin client.

38. The system of claim 33, wherein the system further comprises a database configured to store data associated with the one or more users on the remote server of the cloud provider.

39. The system of claim 33, wherein the interaction includes: group collaboration among learners and educators, team discussion, peer-review, online assessment, examination, and sharing of the educational resources.

40. The system of claim 33, wherein the interaction is provided through a cloud massive online open course network.

41. The system of claim 33, wherein the cloud massive online open course includes: a public cloud massive online open course, a community cloud massive online open course, a hybrid cloud massive online open course, and a private cloud massive online open course.

42. The system of claim 33, wherein the system further comprises one or more catalogues of the educational products or services allowing the one or more users to obtain, configure, and deploy the educational recourses themselves.

43. The system of claim 42, wherein the one or more catalogues include templates that contain predefined configurations and technical information used by the one or more users to build a cloud education infrastructure.

44. The system of claim 33, wherein the one or more users are charged a fee for entering the cloud education environment and using the educational resources.

45. The system of claim 33, further comprising displaying one or more advertisements within the cloud education environment.

46. The system of claim 45, wherein the one or more advertisements are associated with the educational products or services provided by the cloud provider.

47. The system of claim 45, wherein the one or more advertisements are one or more third party advertisements associated with products or services provided by a third party.

48. The system of claim 47, further comprising identifying an interaction level of the one or more users with the one or more third party advertisements.

49. The system of claim 48, further comprising determining a fee payable by the third party based on the interaction level of the one or more users with the one or more third party advertisements.

50. The system of claim 33, further comprising a cloud search engine configured to conduct a keyword search of information requested by the one or more users, wherein the information includes: a text, an audio, a video, an image, and data about instructors.

51. The system of claim 33, further comprising one or more on-demand self-services enabling users to obtain, configure, and deploy educational resources themselves using education service catalogues.

52. The system of claim 33, wherein the cloud massive online open course includes an open free online course aiming at large-scale participants, wherein the open free online course includes open educational resources including distance learning university courses.

53. The system of claim 33, wherein the cloud massive online open course includes a specialized course, a job-oriented course, and a course for passing a test.

54. The system of claim 33, wherein the cloud massive online open course includes one or more traditional courses.

55. The system of claim 33, wherein the cloud massive online open course includes a massive amount of content produced in a plurality of universities, which is aggregated as a news letter, a web page, a mobile application, and a piece of multimedia accessible by the one or more users.

56. The system of claim 33, wherein the cloud massive online open course includes user interaction tools enabling the one or more users to form connections with each other through autonomous, open, diverse, and interactive discourse.

57. The system of claim 33, wherein the cloud provider organizes the one or more users in a predetermined setting, time and place through a network using dedicated online tools.

58. The system of claim 33, wherein the cloud provider may slit expenses with one or more educational institutions who provide online education courses, wherein the expenses include certification fees and tuition fees.

59. The system of claim 33, wherein the cloud massive online open course includes tools for conducting an examination via a webcam.

60. The system of claim 33, further comprising an open source code for the cloud massive online open course platform, including the open source code for at least learning management systems, course authoring tools, application programming interfaces for integrating third-party learning objects, and machine grading application programming interfaces.
